(19) United States
(12) Patent Application Publication
(10) Pub. No.: US 2025/0034001 A1
(43) Pub. Date: Jan. 30, 2025

(54) WATER, MINERALS AND COOLING GENERATION SYSTEM

(71) Applicant: XDI Holdings, LLC, Bedford, NH (US)

(72) Inventor: James Charles Juranitch, Fort Lauderdale, FL (US)

(21) Appl. No.: 18/716,361

(22) PCT Filed: Dec. 2, 2022
(86) PCT No.: PCT/US2022/051672

§ 371 Date: Jun. 4, 2024

Related U.S. Application Data
(60) Provisional application No. 63/286,010, filed on Dec. 4, 2021.

(51) Int. Cl. C02F 1/16; C02F 1/44; C02F 103/08; C02F 103/20

(52) U.S. Cl. CPC C02F 1/16; C02F 1/441; C02F 2103/08; C02F 2103/20; C02F 2303/10

(57) ABSTRACT

Embodiments of the present disclosure relate generally to a method. apparatus and system for the production of clean water, up-cycled minerals and coolant generation. A fuel source to power the system can be any heat source such as a btu rich gaseous or liquid fuel. The system recycles the generated heat to accomplish multiple functions therefor minimizing inefficiency capital investment and waste. Up-cycled valuable products are a byproduct of the process helping to offset Opex costs.

### CROSS-REFERENCE TO RELATED APPLICATIONS

This application claims the benefit of U.S. provisional application No. 63/286,010, filed 4 Dec. 2021, which is hereby incorporated by reference as though fully set forth herein.

### FIELD OF THE INVENTION

Embodiments of the present disclosure relate generally to a method, apparatus and system for the production of clean water, up-cycled minerals coolant generation.

### BACKGROUND

In many parts of the world, the amount of available water that is clean and potable is becoming critical with respect to their lack of availability. Many areas of the world have drained their natural aquifers to a level where salt intrusion or salt water back filling has rendered the existing aquifers contaminated.

Humans around the globe are consuming ever more scarce land as a place to live, as they continue to reproduce and increase in population, which in many cases subtracts from the pool of high-quality tillable land for agriculture. The remaining less desirable land used for agriculture typically requires more fertilizer and more water to produce the same level of crops when compared to a higher quality, more desirable, plot of land that was previously available. The continued increase in population also applies additional pressure on the remaining land that is available.

With the advent of modern climate-controlled living conditions, humans have also settled and prospered in hostile conditions that previously would have had a slower, more maintainable population growth. The ever-increasing populations in these inhospitable locations, again applies more pressure on the already dwindling water resources.

Humans are also causing significant negative changes to their environment such as in the Arabian Gulf where the waste stream from desalination plants are raising the salt concentrations in the Gulf waters to levels where the desalination plants efficiency is decreased and the waters of the gulf are suffering in their environmental quality.

An example of all of these trends can be found in the middle east. In the middle east, there is a dwindling supply of clean water, an increasing level of salt pollution in the gulf waters, an increasing population, and in many areas, for significant parts of the year, a harsh and hot climate. In these hot and harsh areas, the production of cooling for air conditioning, food production, or general municipal cooling is also a valuable resource.

### BRIEF DESCRIPTION OF THE DRAWINGS

FIG. 1 depicts a block diagram of the apparatus and system, in accordance with embodiments of the present disclosure.

FIG. 2 depicts a more detailed example of an embodiment of the apparatus and system, in accordance with the present disclosure.

FIG. 3 depicts some details associated with the cooling portion of the apparatus and system, in accordance with embodiments of the present disclosure.

FIG. 4 depicts details associated with the cooling portion of the apparatus and system, in accordance with embodiments of the present disclosure operating on a feedwater from a desalination plant bypass stream.

### DETAILED DESCRIPTION

An apparatus and system for the efficient production of clean water and coolant generation in water starved locations around the world is needed and can be provided by embodiments included in the present disclosure. Embodiments of the present disclosure can use energy and hardware components associated with embodiments disclosed herein to accomplish multiple tasks at the same time. For example, the waste energy used to power the cooling aspects of the present disclosure can also at the same time, in some embodiments, be used for condensing distilled water. The cost and complexity of a dedicated condenser unit for water production can thus be eliminated. In this example, waste heat can become a primary energy source for a coupled second process. Both the energy stream and the single piece of hardware performs two essential and primary functions at the same time. As an added benefit, there are also no moving parts in the refrigerant generation (cooling system) disclosed herein. This lack of complexity can be ideal for the disclosed novel invention, with respect to performing its work reliably in harsh environments around the world. In some embodiments, beneficial up-cycled products can be produced at the same time clean water and cooling are being manufactured. In other embodiments, the feedwater for the process can be sourced from the waste stream of a desalination plant. The produced clean water can be used directly or re-entered into the feedwater of the desalination plant to dilute the salt content of the desalination plant's feedwater and therefor increase the efficiency of the overall desalination plant in a significant way. Embodiments of the present disclosure provide a method, apparatus and system, which is a step forward in helping the world live in harmony.

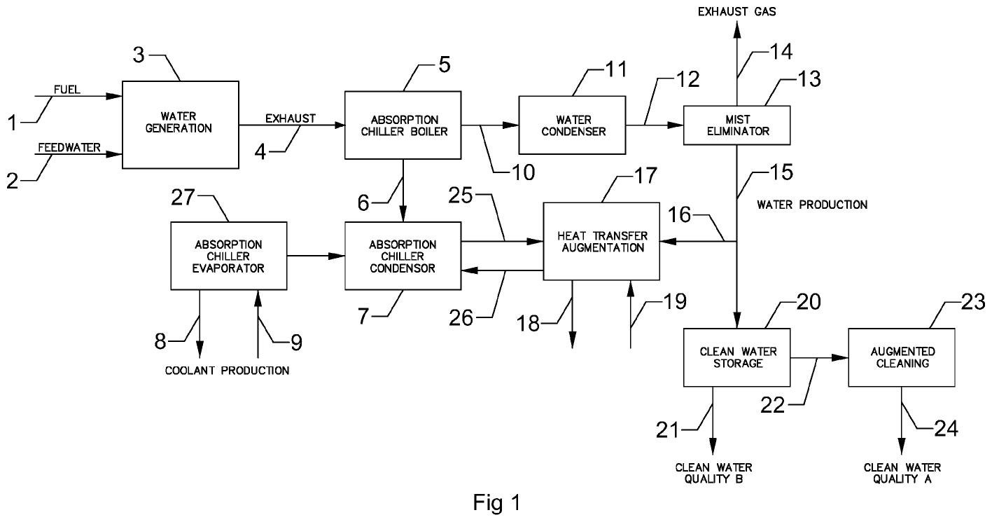

FIG. 1 illustrates a general block diagram for a configuration of this disclosure that produces clean water and generates coolant, in accordance with embodiments of the present disclosure. Fuel provided by a fuel source 1 can be used to generate energy to produce clean water. In some embodiments, water in a feedwater conduit 2, which can include dirty water, can be cleaned by the apparatus and system. The dirty water can be sourced from the waste stream of desalination plants. Embodiments of the present disclosure can include a clean water generator, which can be in fluid communication with the fuel source 1 and the feedwater conduit 2. In some embodiments, the clean water generator 3 can include a distillation unit, a direct contact thermal distillation unit, a submerged combustion distillation unit, a hot forced evaporation system, a multiple effect water purification system and/or any other system that purifies water and rejects waste heat. In some embodiments, the clean water generator 3 can be fluidly coupled with an exhaust outlet 4, which can carry waste heat exhaust ejected from the clean water generator 3. In some embodiments, clean water can be carried by the waste heat exhaust through the remaining stages of the process before the clean water is separated from the waste heat exhaust. In some embodiments included in the disclosure, the clean water could be rejected at the water generator unit 3 and the clean water may not be carried through any remaining portions of the process. In some embodiments, a heat recovery portion of the coolant generation system can utilize exhaust waste heat to drive its process and can be coupled to the water generation system via the exhaust outlet 4 which in some embodiments can be in fluid communication with an absorption chiller boiler. In some embodiments, the absorption chiller 5 can serve multiple purposes, including providing the thermal energy to power a cooling cycle through a form of an absorption cooling cycle, while at the same time it can condense the exhaust stream from the water generator 3. Some embodiments can include a water condenser 11, fluidly coupled with the absorption chiller via an absorption chiller boiler outlet 10. Some embodiments can include a mist eliminator 13, which can be fluidly coupled to the water condenser 11 via a water condenser outlet 12. The remaining exhaust gasses from the process can exit the system through exhaust gas conduit 14 and water can be transferred to a clean water storage tank 20 via a water production conduit 15 and/or also to a heat transfer augmentation process 17, via a conduit 16.

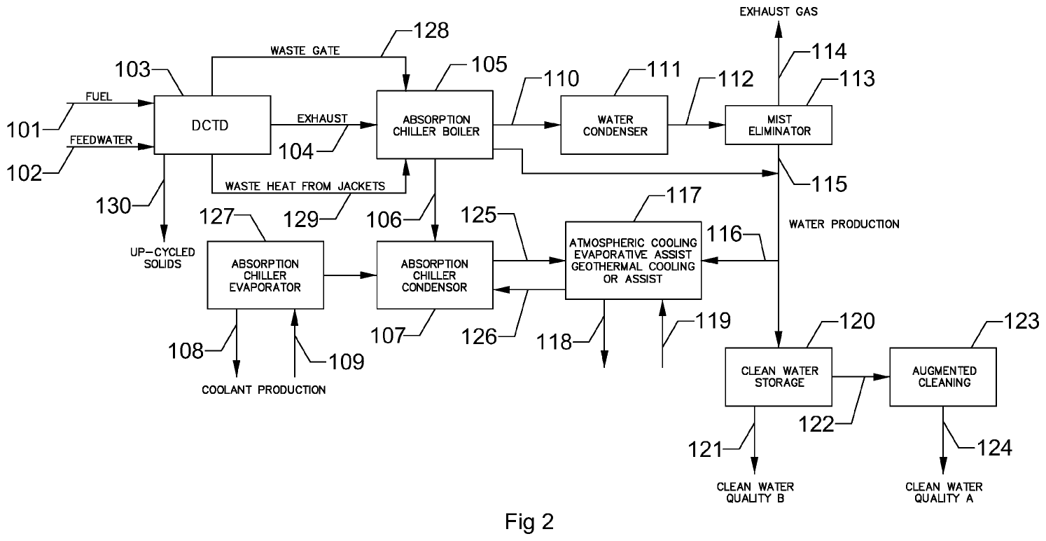

Some embodiments can include an absorption chiller evaporator 27. The absorption chiller evaporator 27 can generate cooling, which can be made available for productive work. The cooling energy generated by the absorption chiller evaporator 27 can be transferred through a coolant outlet conduit 8. In some embodiments, the cooling energy can be transferred to a municipal cooling HVAC system. In some embodiments the cooling can be used for food production, such as for use in fish farms, although examples of use for food production are not so limited and can be used for other uses, as well. A return spent cooling fluid can enter the system through conduit 9, to be recharged. In some embodiments, the system can include an absorption chiller condenser 7, which can be fluidly coupled with the absorption chiller boiler 5 via conduit 6, absorption chiller evaporator 27 and a heat transfer augmentation process 17. In some embodiments, the absorption chiller condenser 7 can extract heat energy from the cooling system. Embodiments of the present disclosure are not limited to absorption chilling systems only. Direct expansion (DX) and electro cooling systems that can utilize waste heat to produce coolant can also be used as viable coolant generation systems in embodiments of the present disclosure. To increase the coolant generation system's efficiency augmented cooling to the condenser portion can be implemented from a heat transfer augmentation process 17. Geothermal cooling from subsurface aquifers of brackish water or other fluids could also be used as recovered through conduits 18 and 19 and their thermal energy directed at augmented cooling A detailed description of some novel heat transfer augmentation systems will be described in more detail in relation to FIG. 2.

Clean water storage can be provided by a clean water storage tank 20. The water quality in clean water storage tank 20 may be improved by the augmented water that is further cleaned and stored via augmented cleaning process 23, which are fluidly coupled via conduit 22. In some embodiments, the augmented cleaning processes 23 can include a membrane cleaning system, such as a reverse osmosis system, which can produce potable water or water that is fit for human consumption. However, examples are not limited to a reverse osmosis system and any other more discriminating water purifying process can be used. Mixtures of blended water from clean water quality A conduit 24 with water in clean water conduit B conduit 21 and potentially feedwater conduit 2 enhance the production of water suited for agricultural crop use, fish farming, livestock consumption and human consumption and many other uses. A near infinite amount of blended water combinations are possible to optimize water production, utilizing a minimum amount of energy and a minimum amount of capital investment.

FIG. 2 is a more detailed example of the process previously described in FIG. 1, in accordance with embodiments of the present disclosure. Embodiments depicted and described with respect to FIG. 2 include same or similar features to those depicted and discussed in FIG. 1 and are denoted by similar reference numerals (e.g., “absorption chiller boiler 5” and “absorption chiller boiler 105”). For ease, not all reference numerals depicted in FIG. 2 that share similar reference numerals to those discussed in FIG. 1 are discussed. In FIG. 2 a fuel source 101 can be used to generate heat. In some embodiments, the fuel source 101 can include well head gas, natural gas, oil and/or any other fuel that contains thermal energy when employed. Some embodiments include a feedwater source 2 that could be unconventional produced water and/or subterranean brackish water and/or petrified water and/or a waste stream from a desalination plant. Some embodiments of the present disclosure can include a direct contact thermal distillation system (DCTD) 103, which can purify water from lightly salt contaminated feedstocks with 5,000 ppm of contaminants or less to fully saturated feedwaters with ppms of 300,000 or greater and more specifically from 50,000 ppm to 290,000 ppm. Volatile organic compounds can also be oxidized in the process. The DCTD system in this example is described more fully in U.S. patent application Ser. No. 17/291,865, which is incorporated by reference as though fully set forth herein.

In some embodiments of the present disclosure, the clean water production system can be optimized to be operated during the higher temperature day conditions primarily configured to produce fresh water. The same system can be optimized to produce and store cooling during a cooler or dryer condition, such as night conditions. The thermal cooling produced can be stored in many ways including heat transfer to water storage tanks or enhanced cooling of a thermal sink such as a fish farm during the cooler periods of the night.

To maximize the process efficiency, waste heat in the exhaust in conduit 104 and waste gate waste energy in conduit 128 and waste heat in conduit 129 can all be directed to act on the absorption chiller boiler 105 in this example. The absorption chiller boiler 105 could be ammonia based but is not limited only to this style of absorption chiller. In some embodiments, the cooling production process could be a DX system, an electro conversion process operated on heat energy or the absorption chiller refrigeration systems could also be a brine system, a lithium bromide system, a lithium chloride system, or other heat transfer system. The absorption chiller boiler 105 can serve 2 functions at the same time. It can condense the steam generated in the DCTD unit 103, while at the same time providing the motive energy for the absorption refrigerant process. In the disclosed example valuable minerals can be recovered from the feedwater and up-cycled as described in U.S. patent application Ser. Nos. 16/461,296 and 16/486,578, incorporated by reference as though fully set forth herein to minimize the Opex of the process and improve the sustainability of the process. In many fossilized feedwaters valuable minerals such as lithium, chlorides, bromides, barium, boron, copper, iron, silver, magnesium, strontium and many other minerals are available in significant quantities to be readily harvested through up-cycled solids conduit 130, as described more fully in U.S. patents application Ser. Nos. 16/461,296 and 16/486,578, incorporated by reference as though fully set forth herein. In some embodiments, water condenser 111 and/or mist eliminator number 113 may or may not be included in the method, apparatus and system for the production of clean water and coolant generation disclosed herein.

In some embodiments, the optimization of the absorption chiller condenser 107 for desert operations can be enhanced by redirecting a portion of the purified water in conduit 115 through conduit 116 to a spray system 117 that enhances condenser efficiency through evaporative cooling. Geothermal cooling from subsurface aquifers of brackish water or other fluids could also be used as recovered through conduits 119 and 118 and their thermal energy directed at augmented cooling on the absorption chiller condenser shown 107.

The water generated and stored in clean water storage tank 120 could be generated at a purity level of 10 ppm from a discerning DCTD to 30,000 ppm from a simplified DCTD. A preferred range of operation of water in the clean water storage tank can may be from 600 ppm to 5,000 ppm, or from 600 ppm to 3,000 ppm which would provide a quality of water that could be utilized for farming and feedstock applications, for example. The water from the clean water storage tank 120 could then be efficiently purified to human consumption levels of quality by a reverse osmosis system and then stored in augmented cleaning process 123.

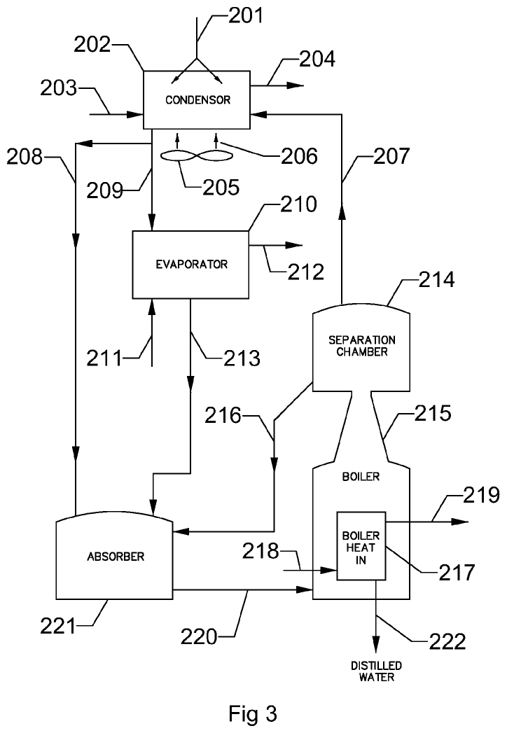

FIG. 3 is a detailed block diagram of a novel ammonia/water absorption refrigeration system, method, and apparatus for the production of clean water and coolant generation, in accordance with embodiments of the present disclosure.

Some embodiments of the present disclosure can include an ammonia condenser 202. In some embodiments, the ammonia condenser 202 can have a conventional air to air heat transfer system, as shown, which can include a fan 205, blowing air 206. As depicted, in some embodiments, the condenser 202 can include a heat load in conduit 203 and a processed and reduced heat load out conduit 204. In some embodiments, the air to air heat transfer system can be augmented by a slip stream of clean water generated by the DCTD which is acted upon ammonia condenser 202 to produce evaporative cooling by conduit 201. Subterranean geothermal cooling could also be transferred to condenser 202 through a closed cooling loop. Boiler 215 can be configured to accept waste heat in this example from a DCTD from item 217 through conduits 218 and 219 to drive a mixture of ammonia and closed process water into separation chamber 214, which can be fluidly coupled with the condenser 202 via a transfer conduit. The steam rich flow in conduit 218 can be condensed out to flow through conduit 222 as distilled water, providing two forms of useful work from the same energy source. In some embodiments, conduit 216 can provide an ammonia poor water back pipe for the process. The produced coolant energy can be harvested from the evaporator 210 in an air-to-air HVAC heat transfer system or in a fluid closed loop cooling system represented by conduits 211 and 212. In some embodiments, the evaporator can be in fluid communication with the condenser 202 via a liquid ammonia conduit 209. The evaporator 210 can be in fluid communication with the absorber 221 via an ammonia gas pipe 213 and conduit 208 can be a pressure balance conduit charged preferably with hydrogen in embodiments of the present disclosure. In some embodiments, the absorber 221 can be in fluid communication with the boiler 215 via an ammonia and water transfer conduit 220.

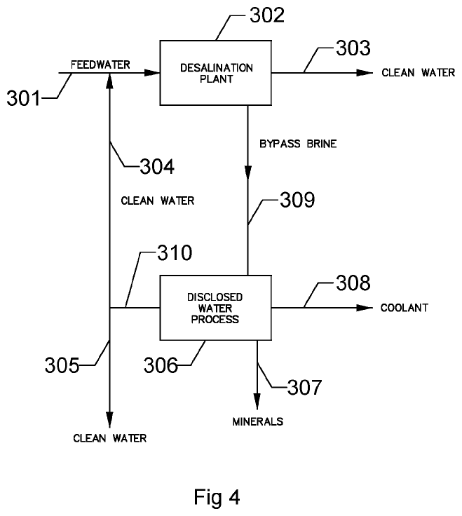

FIG. 4 depicts an embodiment where feedwater is provided to a desalination plant 302 via a feedwater conduit 301, in accordance with embodiments of the present disclosure. In some embodiments, the feedwater can include ocean water. Some embodiments can include a desalination plant 302, which could be a reverse osmosis plant, a multiple effect distillation plant (MED), a multiple stage flash plant (MSF), or any other type of desalination process or plant that has a waste stream. In some embodiments, the desalination plant 302 can produce a clean water product, which can pass through a clean water conduit 303. In some embodiments, a bypass brine conduit 309 can be in fluid communication with the disclosed clean water generator method, apparatus and system for the production of clean water, up-cycled minerals coolant generation, represented by block 306. The bypass brine conduit 309 can transfer the desalination plant's waste or brine water. In some embodiments, conduit 310 can contain the disclosed method, apparatus and system for the production of clean water, up-cycled minerals coolant generation clean water, which could be communicated through conduit 304 back to the desalination plant to dilute the feedwater for the plant. In some embodiments, the clean water can be expelled through conduit 305, to be used for consumption by humans. In some embodiments, coolant can be transferred from the disclosed water process 306 via coolant conduit 308. In some embodiments, upcycled minerals can be transferred from the disclosed water process 306 via upcycled minerals conduit 307. One or more of the coolant production and mineral upcycling can be included or excluded in embodiments of the present disclosure embodiment.

Embodiments are described herein of various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment”, or the like, means that a particular feature, structure, or characteristic described in connection with the embodiment(s) is included in at least one embodiment. Thus, appearances of the phrases “in various embodiments,” “in some embodiments,” “in one embodiment,” or “in an embodiment,” or the like, in places throughout the specification, are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

Although at least one embodiment for a dirty water treatment optimization has been described above with a certain degree of particularity, those skilled in the art could make numerous alterations to the disclosed embodiments without departing from the spirit or scope of this disclosure. All directional references (e.g., upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the devices. Joinder references (e.g., affixed, attached, coupled, connected, and the like) are to be construed broadly and can include intermediate members between a connection of elements and relative movement between elements. As such, joinder references do not necessarily infer that two elements are directly connected and in fixed relationship to each other. It is intended that all matter contained in the above description or shown in the accompanying drawings shall be interpreted as illustrative only and not limiting. Changes in detail or structure can be made without departing from the spirit of the disclosure as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

1. A method, apparatus and system for the production of clean water and coolant generation where the coolant generation is powered by waste heat from the clean water production system.

2. A method, apparatus and system for the production of clean water and coolant generation where the coolant generation is powered by waste heat from the clean water production system and minerals are recovered or up-cycled from the feedwater.

3. A method, apparatus and system for the production of clean water where the feedwater is the rejected waste brine from a desalinization plant.

4. The method of claim 3 where the clean water produced by the system is reintroduced into the feedwater of the desalinization plant.

5. The method of claims 3 and 4 where optional cooling and upcycled minerals are produced.

6. A system as in claims 1, 2 and 3 where the overall efficiency of the cooling generation is enhanced by evaporative cooling.

7. A system as in claim 6 where the evaporative cooling is originated from a slip stream of produced purified water.

8. A system as in claims 1,2 and 3 where the overall efficiency of the cooling generation is enhanced by augmented thermal transfer of geothermal energy to a component in the coolant generation system.

9. A system as in claim 8 where the geothermal augmented thermal energy transfer is extracted from a subterranean aquifer.

10. A system as in claim 8 where the geothermal augmented thermal energy transfer is extracted from a subterranean brackish deposit or petrified ocean deposit.

11. A system as in claim 1, 2 or 3 where the coolant generation system is powered by waste heat which is also used to condense the steam in the distillation process.

12. A system in claim 1, 2 or 3 where multiple qualities of clean water are produced.

13. A system of claim 12 where the multiple qualities of clean water are blended to produce a desired final fluid quality.

14. A system of claim 12 where reverse osmosis or another discriminating water purification process is used to augment the process of producing a high-quality clean water supply.

15. A process of claim 1, 2 or 3 where the cooling is utilized for agriculture production.

16. A process of claim 1, 2 or 3 where the cooling is utilized for municipal cooling.

17. A process of claim 1, 2 or 3 where the cooling is utilized for fish farming.

18. A process of claims 1, 2 and 3 where clean water production is optimized during hotter temperature or more humid periods and the production of cooling is optimized during the cooler or dryer parts of a day.

19. A process of claim 18 where the produced coolant thermal energy is stored.
